(19) United States
(12) Patent Application Publication
(10) Pub. No.: US 2013/0044504 A1
(43) Pub. Date: Feb. 21, 2013

(54) LED LIGHT SOURCE TURN-ON DEVICE FOR HEADLAMP

(71) Applicants: Hiroki Ushio, Tokyo (JP); Fumihiro Minami, Tokyo (JP); Takashi Ohsawa, Tokyo (JP)

(72) Inventors: Hiroki Ushio, Tokyo (JP); Fumihiro Minami, Tokyo (JP); Takashi Ohsawa, Tokyo (JP)

(73) Assignee: MITSUBISHI ELECTRIC CORPORATION, Tokyo (JP)

(21) Appl. No.: 13/643,028

(22) PCT Filed: Jul. 5, 2010
(86) PCT No.: PCT/JP2010/004382

§ 371 Date: Oct. 23, 2012

(51) Int. Cl. B60Q 1/04; F21V 29/00; F21V 5/04

(52) U.S. Cl. 362/520

(57) ABSTRACT

There is provided a light source lighting device for a headlamp including: a headlamp case to which a front lens is attached; and a planar fixation section that is inserted into the headlamp case, together with an optical component having a light source, from a front opening portion formed in the headlamp case, and that is fixed along an inner wall of the headlamp case.

### TECHNICAL FIELD

The present invention relates to a light-source lighting device for a headlamp (hereinafter, abbreviated to a lighting device) that lights a discharge lamp or an LED (Light Emitting Diode) as a light source for a headlamp.

### BACKGROUND ART

As a light source for a headlamp, in place of a conventional halogen lamp, a discharge lamp (HID lamp (High Intensity Discharge Lamp)) having long life and high brightness is widespread, and next the prevalence of an LED is also in progress.

Especially, the LED has long life and requires no replacement thereof, and therefore it is unnecessary to provide an opening portion for light source replacement that is necessary in the case where the conventional halogen lamp or discharge lamp is used in a headlamp case, so that the headlamp case can have a simple configuration. However, like the discharge lamp, the LED needs a lighting (turn-on) device for lighting the LED; thus, it is required to secure a space for the attachment of the lighting device and improve an assemblability of the lighting device, and a shape thereof capable of an easy assembly to a simple headlamp case is desired.

A conventional prior art disclosed in Patent Document 1 has an arrangement such that an LED is disposed at a position opposing a concave mirror and the light emitted by the LED is irradiated to an area ahead of a vehicle, and that a power supply circuit (lighting device) is integrated with a light source module (LED) and disposed at the upper portion of a headlamp case.

A conventional prior art described in Patent Document 2 has an arrangement such that in a headlamp using an LED as a light source, in order to dissipate effectively the heat emitted by a lighting device, the lighting device is attached to the outer surface of a housing (headlamp case), a heat shielding portion is provided between the internal space of the headlamp case and the lighting device, and that the lighting device is disposed at the lower portion of the headlamp case.

### PRIOR ART DOCUMENTS

### Patent Documents

Patent Document 1: Japanese Patent Application Laid-open No. 2005-063754

Patent Document 2: Japanese Patent Application Laid-open No. 2009-283199

### SUMMARY OF THE INVENTION

However, in any of the prior arts described above, there is no description of an arrangement such that the lighting device is inserted from a front opening portion of the headlamp case and that the lighting device is fixed along an axial direction which is a direction of the insertion and in which the front opening portion of the headlamp case is formed; the lighting device has to be assembled in a process different from a process of assembling other constituent components for the headlamp such as an optical component and so on, and it is not possible to assemble the headlamp through a series of consecutive work. For this reason, there has been a problem such that complicated processes and non-consecutive work may deteriorate productivity (mass productivity) and increase the manufacturing cost of products.

The present invention is made to solve the aforementioned problem, and an object of the invention is to provide a light source lighting device for a headlamp having an arrangement that can be inserted from a front opening portion of a headlamp case to be assembled thereto, like a light source containing an optical member or a front glass, and can be fixed along an axial direction in which the front opening portion of the headlamp case is formed, and has a simple arrangement that makes much account of an assemblability thereof.

A light source lighting device for a headlamp according to the present invention includes: a headlamp case into which a light source containing an optical member is inserted; and a planar fixation section inserted from a front opening portion formed in the headlamp case, and fixed along the inner wall of the headlamp case.

According to the invention, like the light source containing the optical member or the front glass, the planar fixation section is inserted from the front opening portion of the headlamp case and then the planar fixation section is fixed along the inner wall of the headlamp case; thus, it is possible to insert the lighting device into the interior of the headlamp case to be assembled through a series of consecutive assembly work processes from the same direction, thereby enhancing working efficiency thereof and improving the productivity of the headlamp.

### BRIEF DESCRIPTION OF THE DRAWINGS

FIG. 1 is a longitudinal sectional side view of a headlamp to which a lighting device according to the present invention is assembled and fixed.

FIG. 2 is an exploded side view of individual constituent components of FIG. 1.

FIG. 3 is a longitudinal sectional side view of the headlamp in which the assembled and fixed position of the lighting device according to the invention is different from that of FIG. 1.

FIG. 4 is a transverse sectional view along a line 1-1 of FIG. 3.

FIG. 5 is a longitudinal sectional side view of a main part showing a modification of FIG. 3.

FIG. 6 is a transverse sectional view along a line 2-2 of FIG. 5.

FIG. 7 is an external perspective view of the lighting device.

FIG. 8 is a perspective view showing the state of the lighting device before the assembly of an external case.

FIG. 9 is a longitudinal sectional side view of a main part showing a state in which a planar fixation section of a plate member interposed between an inner wall of a headlamp case and a lighting device is fixed to the inner wall thereof.

FIG. 10 is a longitudinal sectional side view of a main part in which an opening is provided in a headlamp case to oppose a plate member interposed between the headlamp case and a lighting device.

FIG. 11 is a longitudinal sectional side view of a main part showing a state in which heat dissipating fins formed on a plate member are protruded from the opening of a headlamp case to the outside.

FIG. 12 is a front view of the plate member as viewed from the side of the heat dissipating fins.

FIG. 13 is a longitudinal sectional view of a main part in which it is configured that constituent components are accommodated in a housing, and that a closing member for covering an opening of the housing is fixed to the inner wall of a headlamp case together with a planar fixation section of the housing.

FIG. 14 is a longitudinal sectional view of a main part in which it is configured that constituent components are accommodated in a housing, and that the fixation of a closing member for covering an opening of the housing to the housing and the fixation of the closing member to the inner wall of a headlamp case are performed from different directions.

FIG. 15 is a longitudinal sectional view of a main part in which it is configured that constituent components are accommodated in a housing and that the housing is fixed to the inner wall of a headlamp case without using a screw.

FIG. 16 shows a fixing jig used in FIG. 15: FIG. 16(a) is a perspective view of a part thereof; and FIG. 16(b) is a side view thereof.

FIG. 17 is a longitudinal sectional view of a main part showing another configuration in which it is configured that constituent components are accommodated in a housing and that the housing is fixed to the inner wall of a headlamp case without using the screw.

FIG. 18 is an exploded perspective view showing still another configuration in which it is configured that constituent components are accommodated in a housing and that the housing is fixed to the inner wall of a headlamp case without using the screw.

FIG. 19 is a longitudinal sectional side view of a headlamp in which it is configured that constituent components are accommodated in a housing and that the housing is exposed from the opening of a headlamp case to the outside to be fixed thereto.

FIG. 20 is an enlarged cross-sectional view of a screw attachment portion of the housing to the headlamp case.

FIG. 21 is an enlarged cross-sectional view of a main part showing a modification of FIG. 19.

FIG. 22 is a left side view of FIG. 21.

FIG. 23 is a right side view of FIG. 21.

### BEST MODE FOR CARRYING OUT THE INVENTION

In the following, in order to explain the present invention in more detail, embodiments of the invention will be described with reference to the accompanying drawings.

### Embodiment 1

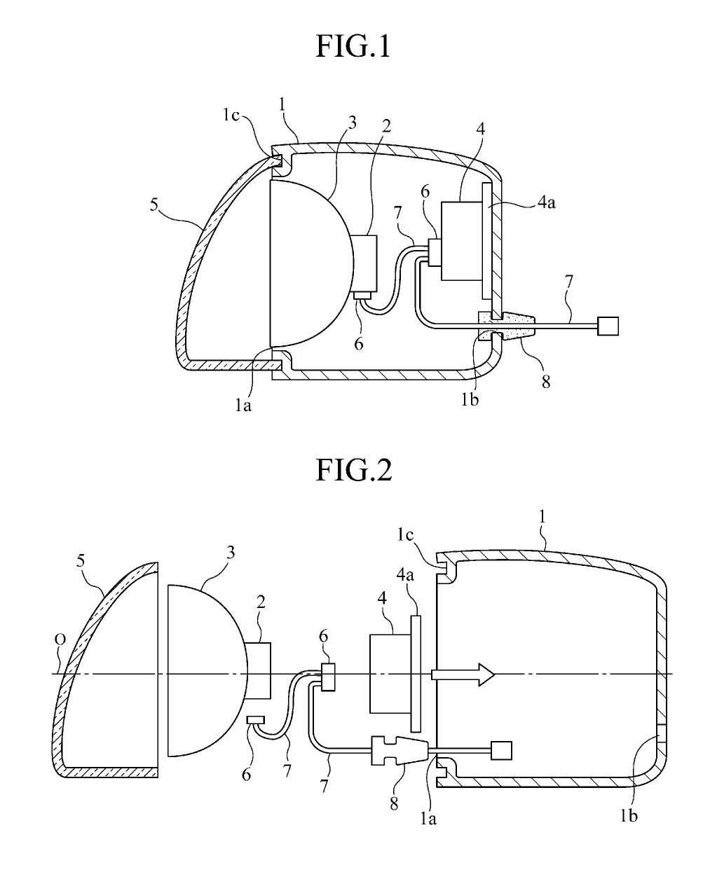

FIG. 1 is a longitudinal sectional side view of a headlamp to which a lighting device according to the present invention is assembled and fixed. The lighting device is assembled to an inner wall of a headlamp case having a waterproof structure, and the lighting device does not need to have the waterproof structure. In the interior of a headlamp case 1, an optical component 3 including a light source 2 is attached and fixed through a support member (not shown), and a lighting device 4 for controlling the lighting of the light source 2 is fixed to the inner wall of the headlamp case by means of a planar fixation section 4a. A front glass 5 is attached to a front opening portion 1a of the headlamp case 1. The light source 2 and the lighting device 4 are connected with a wiring (harness) 7 via connectors 6, and the lighting device 4 is connected to an external power supply source (not shown) via the wiring 7. The wiring 7 is passed through an insulator 8 fitted in a hole 1b of the headlamp case 1, and is pulled out to the outside.

Specifically, the constituent components of a lighting device for lighting a discharge lamp include:
a DC/DC converter section constituted by a coil, an FET, a rectifier diode and so on that increases the voltage of a battery to the voltage of the discharge lamp,
an inverter section for converting a voltage generated by the DC/DC converter into a rectangular wave,
an igniter section for applying a high voltage pulse for starting to the discharge lamp,
a current detection section for detecting a current passed through an LED,
a voltage detection section for detecting a voltage applied to the LED,
a control section that performs a control for holding the detected current of the current detection section constant, a control for stopping an operation in the event that the detected voltage of the voltage detection section is abnormal, and so on and
a connector section that performs the input of the power from a power supply and the output of the power to the LED, and these constituent components are accommodated in a housing, and a part of the housing functions as a heat sink for dissipating the heat emitted by the accommodated constituent components.

In addition, the constituent components of a lighting device for lighting an LED include:
a DC/DC converter section constituted by a coil, an FET, a rectifier diode and so on for increasing or decreasing the voltage of a battery to the voltage of the LED, or a current limitation section for suppressing a current passed through the LED,
a current detection section for detecting the current passed through the LED,
a voltage detection section for detecting a voltage applied to the LED,
a control section that performs a control for holding the detected current of the current detection section constant, a control for stopping an operation in the event that the detected voltage of the voltage detection section is abnormal, and so on and
a connector section that performs the input of the power from a power supply and the output of the power to the LED, and these constituent components are accommodated in the housing (not used in some cases) and a part of the housing functions as a heat sink for dissipating the heat emitted by the accommodated constituent components.

FIG. 2 is an exploded side view of individual constituent components for explaining assembly processes of FIG. 1, and schematically shows that the constituent components are inserted from the front opening portion 1a of the headlamp case 1 toward a direction of an arrow to be assembled; a central line O indicates an axial direction in which the front opening portion 1a of the headlamp case 1 is formed.

First, the lighting device 4 is inserted into the headlamp case 1 from the front opening portion 1a, and the planar fixation section 4a of the back surface thereof is bonded and fixed to the vertical inner wall of the headlamp case by a variety of fixing means of a screw and the like. Next, the light source 2 and the lighting device 4 are connected to each other using the connectors 6 provided at both ends of the wiring 7, another wiring 7 of which one end is connected to the connector 6 is passed through the insulator 8 and is pulled out to the outside through the hole 1b in the vertical inner wall of the headlamp case 1, and the insulator 8 is inserted into and fixed to the hole 1b. Then, the optical component 3 including the light source 2 is inserted into the headlamp case 1 from the front opening portion 1a to be attached and fixed thereto through the support member (not shown), and thereafter the whole circumference of the front glass 5 is fitted in a concave portion 1c formed in the whole circumference of the end surface of the front opening portion 1a of the headlamp case 1 to be fixed thereto airtightly.

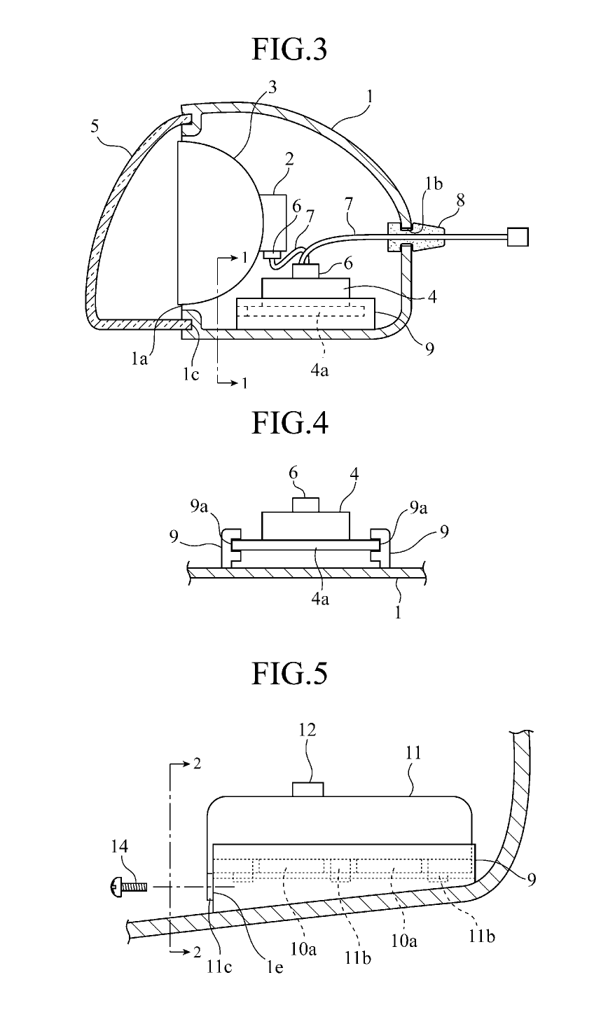

FIG. 3 shows an example of a configuration in which the attachment position of the lighting device 4 is different from that of FIG. 1 and the lighting device 4 is fixed to the inner wall of the bottom surface of the headlamp case 1, and a support portion 9 for supporting the planar fixation section 4a of the lighting device 4 is formed on the inner wall of the bottom surface. In the support portion 9, as shown in FIG. 4, concave portions 9a into which both sides of the planar fixation section 4a are inserted are formed, and the concave portions 9a are provided opposite to each other to be apart from each other by the width of the planar fixation section 4a. Consequently, the lighting device 4 is inserted into the headlamp case 1 from the front opening portion 1a and both sides of the planar fixation section 4a are fitted and pushed in the concave portions 9a of the support member 9 as shown in FIG. 4, and therefore the lighting device 4 can be assembled and fixed to a predetermined position within the headlamp case 1.

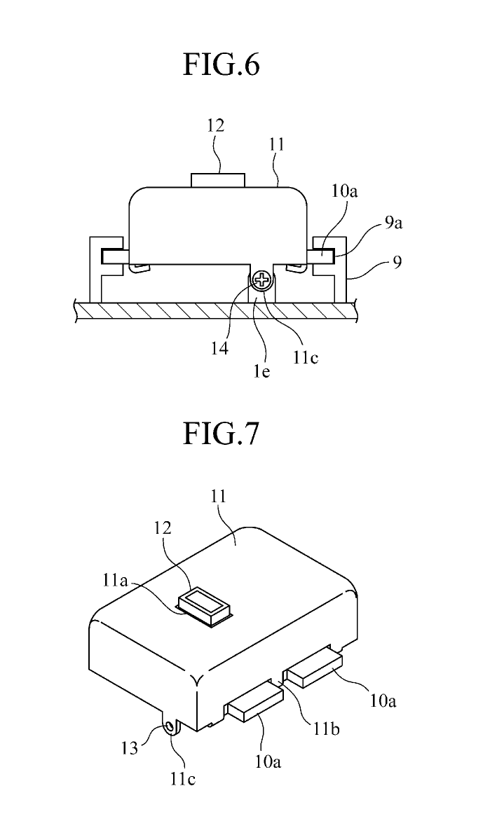

FIG. 5 is a longitudinal sectional side view of a main part showing another modification in which the attachment position of a lighting device 4 is fixed to the inner wall of the bottom surface of a headlamp case 1, and FIG. 6 is a transverse sectional view thereof. In the modification, a receiving stand le for receiving the lighting device 4 is provided on the inner wall of the bottom surface of the headlamp case 1, and support portions 9 are also formed on both sides to sandwich a receiving stand 1e.

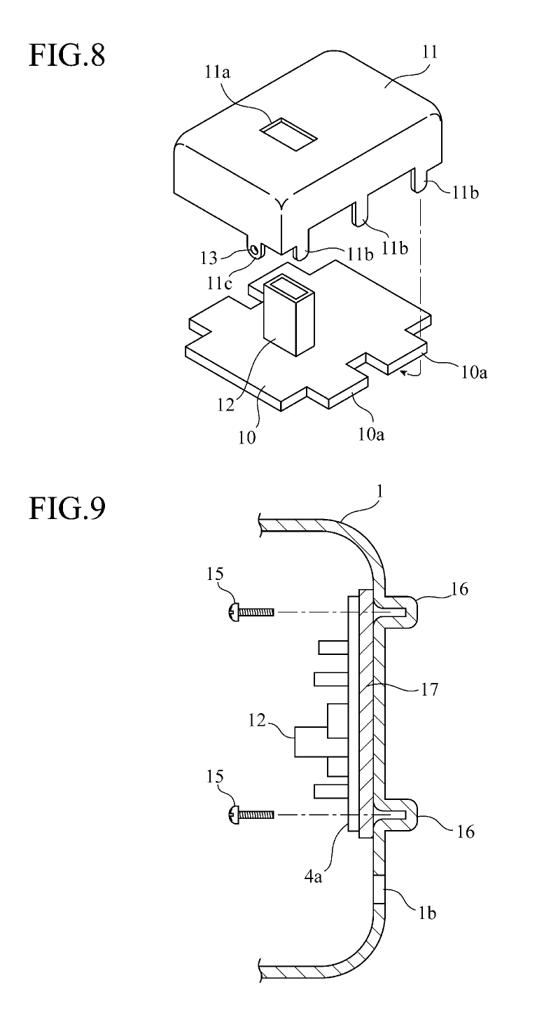

As shown in FIG. 8, the lighting device 4 includes: a base 10 to which an outlet 12 for the connection of a connector 6 is attached; and a cover 11 for covering the base. The base 10 has engagement pieces 10a, 10a as a planar fixation section which are protrusively provided at both side edges thereof; the cover 11 has an opening 11a through which the outlet 12 passes on the upper surface thereof, bending pieces 11b, 11b positioned between the engagement pieces 10a, 10a are protrusively provided at both side edges of the cover 11, and an attachment piece 11c provided with a screw hole 13 is protrusively provided at a rear end edge of the cover 11.

Because of the above-described configuration, the cover 11 is placed over the base 10 with the outlet 12 passed through the opening 11a, the bending pieces 11b, 11b at both side edges thereof are folded back toward the back side of the base to be assembled thereto as shown in FIG. 7. Then, the assembled lighting device 4 is inserted into the headlamp case 1 from the front opening portion 1a, the engagement pieces 10a, 10a protruding on both sides of the cover 11 are fitted and pushed in the concave portions 9a of the support portions 9, the attachment piece 11c is brought into contact with the front surface of the receiving stand 1e, and a screw 14 passed through the hole 13 is screwed in the receiving stand 1e, and prevention of disconnection thereof is thereby implemented and the lighting device 4 is firmly fixed within the headlamp case 1.

As described above, according to Embodiment 1, like the light source including the optical member or the front glass, the lighting device 4 is inserted into the headlamp case 1 from the front opening portion 1a from the same direction and the planar fixation section 4a is fixed along the inner wall of the headlamp case 1, and therefore the lighting device 4 can be inserted into the interior of the headlamp case 1 to be assembled thereto through a series of consecutive work processes, so that workability thereof is enhanced, which improves the productivity of the headlamp.

### Embodiment 2

FIG. 9 shows Embodiment 2, and is a longitudinal sectional side view of a main part showing the state where a planar fixation section 4a of a lighting device 4 is fixed to the inner wall of a headlamp case 1 with screws 15: threaded hole portions 16 are protrusively provided toward the outside on the vertical surface of the headlamp case 1.

With this configuration, the lighting device 4 is inserted into the headlamp case 1 from the front opening portion 1a, and the screws 15 passed through screw holes (not shown) opened in the peripheral parts of the planar fixation section 4a are screwed into the threaded hole portions 16 to be fixed therein. In this instance, a plate member 17 having a function of dissipating the heat emitted by the constituent components of the lighting device 4 is interposed between the inner wall of the headlamp case 1 and the planar fixation section 4a of the lighting device 4. A member having a high thermal conductivity such as aluminum or the like is used as the plate member 17, constituent components such as an electronic component and the like for lighting are supported by the plate member 17, and at the same time the emitted by the electronic component is dissipated from the plate member 17.

However, in order to prevent damage to the constituent components due to the entry of a finger of an operator, a tool, or a foreign material, as shown in FIGS. 7 and 8 mentioned above, it is possible to use a resin cover for covering the constituent components, or also a metallic cover for covering the constituent components in order to suppress an effect of noise of radio noise attenuation and so on.

As described above, according to Embodiment 2, the lighting device 4 is assembled and fixed in the headlamp case 1, and in this fixation state, it is possible to dissipate the emitted by the constituent components via the plate member 17, avert the overheat of the constituent components, and prevent the degradation of the constituent components to thereby prevent breakdowns thereof.

### Embodiment 3

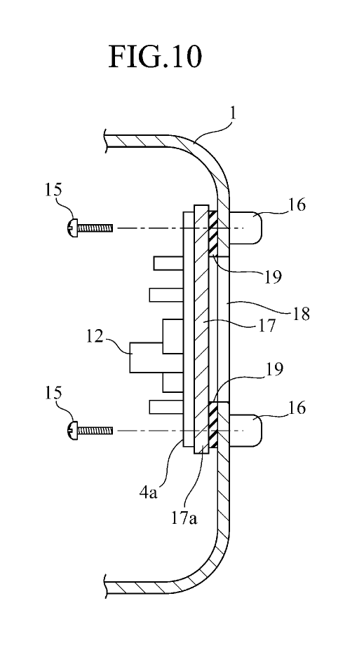

FIG. 10 shows Embodiment 3, and is a longitudinal sectional side view of a main part in which an opening 18 is provided in a headlamp case 1 to oppose a plate member 17 fixed together with a planar fixation section 4a of a lighting device 4, and at least a part of the plate member 17 is exposed from the opening 18 to the outside.

According to Embodiment 3, the heat emitted by the lighting device 4 and a light source 2 assembled in the headlamp case 1 stays in the headlamp case 1, which is easily brought to a high temperature, but the heat emitted by the constituent components of the lighting device 4 is dissipated to the outside via the plate member 17 exposed from the opening 18 of the headlamp case 1. On the other hand, a waterproof member 19 such as adhesive or rubber sheet is interposed between the inner wall of the headlamp case 1 and a planar fixation section 17a of the plate member 17 in order to secure a waterproof property to the opening 18, and therefore it is possible to prevent the entry of water into the headlamp case 1 and, even when a part of the headlamp case 1 is opened and a part of the lighting device is exposed, it is possible to secure the waterproof property of the headlamp case 1.

### Embodiment 4

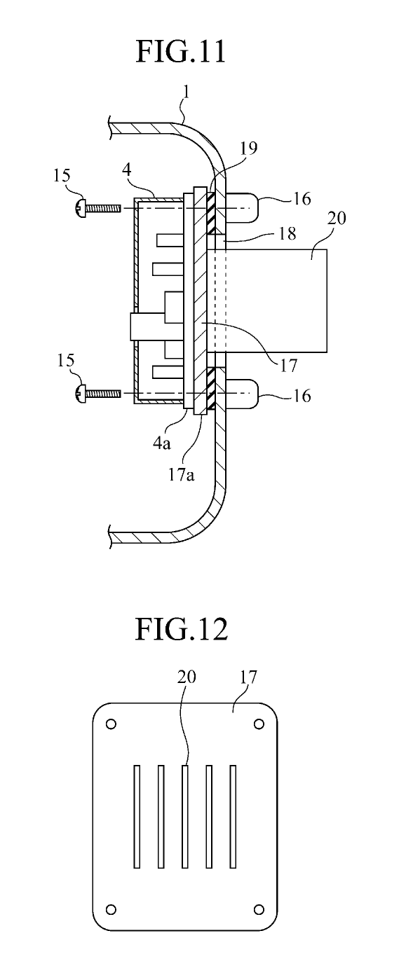

FIGS. 11 and 12 show Embodiment 4 and have a configuration in which heat dissipating fins 20 formed on a plate member 17 are protruded from an opening 18 of a headlamp case 1 to the outside, and the other configuration thereof is the same as that of Embodiment 3 in FIG. 10. Consequently, according to Embodiment 4, the waterproof property of the headlamp case 1 is secured, and further there is an effect such that the effect of dissipating the heat emitted by the constituent components of a lighting device 4 is enhanced.

### Embodiment 5

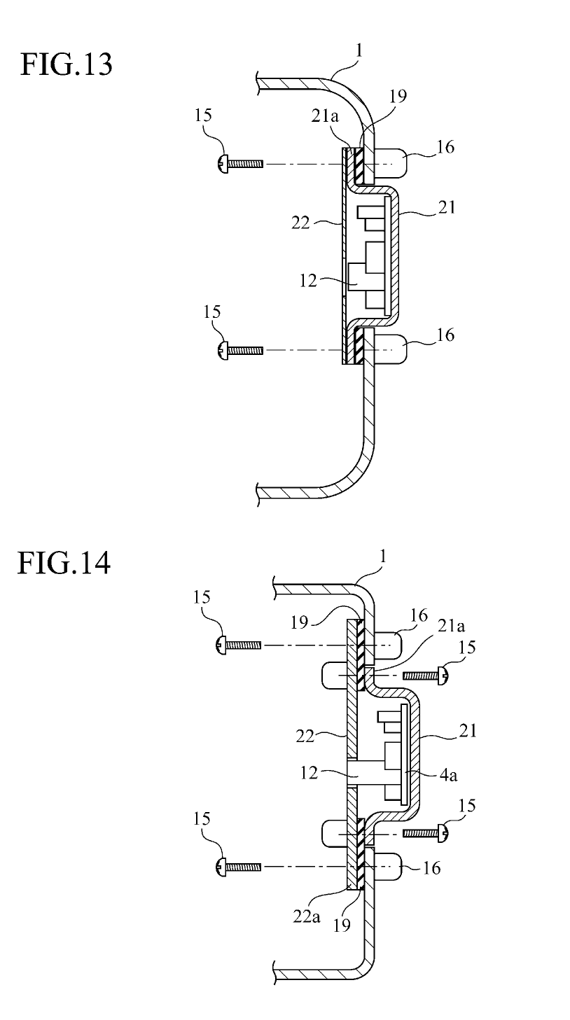

FIG. 13 shows Embodiment 5 and has the following configuration: the constituent components of the lighting device 4 are accommodated and fixed in a housing 21 having a U-shaped cross section that has a function of dissipating the heat emitted by the constituent components of the lighting device 4, a flange outwardly formed at an opening end of the housing 21 is used as a planar fixation section 21a, the fixation section 21a having a waterproof member 19 such as adhesive or rubber sheet interposed therebetween, and also a closing member (plate) 22 for covering the opening end of the housing 21 is placed thereon, and the whole structure is pressed against and fixed to the inner wall of the headlamp case 1 with screws 15.

As the material for the housing 21, aluminum or the like having a high thermal conductivity that dissipates the heat emitted by constituent members accommodated therein is used, and a heat dissipating fin for enhancing the effect of dissipating the heat can also be formed on the outer surface of the housing 21. Note that as the closing member 22 for covering the opening portion of the housing 21, an inexpensive resin having a favorable formability is used, while a metal can be used as a member for measures against noise of radio noise attenuation and so on.

According to Embodiment 5, the housing 21 that accommodates the constituent components of the lighting device 4 is protruded to the outside of the headlamp case 1, and therefore it is possible to effectively use the space in the headlamp case 1 without occupying the space therein, and constitute a lighting device having a high heat dissipating effect. In addition, even when a part of the headlamp case 1 is opened and a part of the lighting device 4 is exposed, it is possible to secure a sufficient waterproof property of the headlamp case 1 by the waterproof member 19.

### Embodiment 6

FIG. 14 shows Embodiment 6, and has a configuration in which a housing 21 having a function of dissipating heat and a closing member 22 for closing the opening portion of the housing 21 are used, and at least apart of the housing 21 is extended through the opening 18 protrusively provided in the headlamp case 1 to the outside. As a material for the housing 21, aluminum or the like having a high thermal conductivity capable of dissipating the heat emitted by the constituent members accommodated therein is used, and a heat dissipating fin for enhancing the heat dissipating effect can also be formed on the outer surface of the housing 21. Note that as the closing member 22 for closing the opening portion of the housing 21, an inexpensive resin having a favorable formability is used, while a metal can be used as a member for measures against noise of radio noise attenuation and so on.

The housing 21 is attached to the closing member 22 with screws 15 with a waterproof member 19 of adhesive, rubber sheet or the like interposed therebetween, the housing 21 is inserted into the headlamp case 1 from a front opening portion 1a, the housing 21 is protruded from the opening 18 to the outside, the peripheral part of the closing member 22 is brought into contact with the inner wall of the headlamp case 1 via the waterproof member 19, and a planar fixation section 22a therearound is pressed against and fixed to the inner wall of the headlamp case 1 with the screws 15.

According to Embodiment 6, the housing 21 and the closing member 22 are fixed to the closing member 22 and the inner wall of the headlamp case 1, respectively, from different directions, and therefore when the constituent component in the housing 21 is replaced due to a breakdown thereof, the replacement can be completed by detaching only the housing 21 therefrom, so that maintenance thereof is allowed; thus, it is possible to keep the cost required for repairs thereof low.

### Embodiment 7

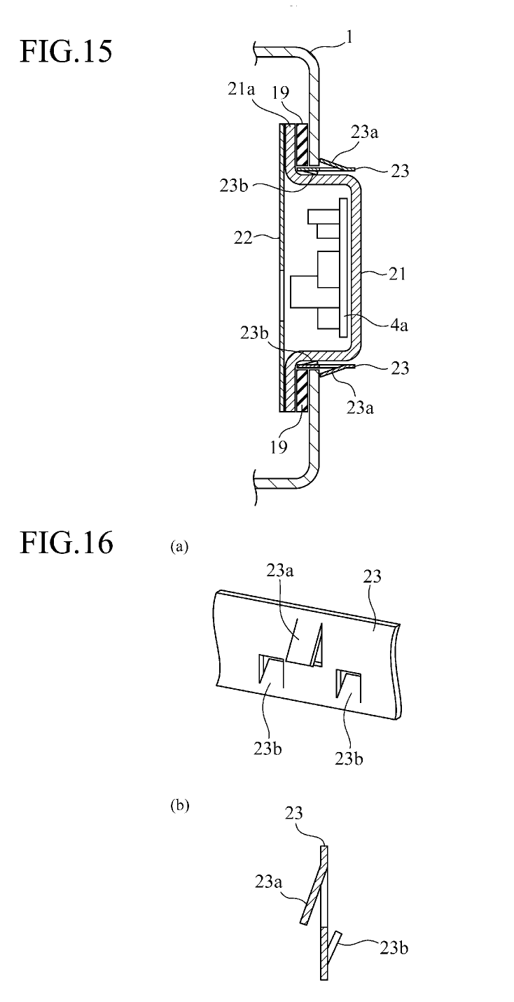

FIG. 15 shows Embodiment 7, and has a configuration that in a configuration such that a part of a housing 21 accommodating a lighting device 4 is protruded to the outside of a headlamp case 1 as shown in Embodiments 5 and 6, the housing 21 is attached and fixed to the headlamp case 1 by a snap-fit method without using a screw. In Embodiment 7, there are provided fixing members 23 interposed between the opening edge of the headlamp case 1 and the housing 21.

As shown in FIGS. 16(a), 16(b), a fixing member 23 is obtained by providing cut-bent (lanced) pieces 23a and 23b on both sides of a metal plate, and the fixing member 23 is press-fit into the opening 18 in a state where the fixing member 23 is brought in contact with the outer peripheral surface of the housing 21 inserted into the headlamp case 1 from a front opening portion 1a. In this way, the cut-bent piece 23a is pressed by the edge of the opening to be reduced in diameter upon the press-fitting; however, when passed through the opening 18, the cut-bent piece 23a is restored, and brought into contact with the outer surface of the headlamp case 1, which functions so that no housing 21 returns to the inside of the headlamp case 1. In addition, the other cut-bent piece 23b is brought into contact with the outer surface of the housing 21 by an elastic restoring force to firmly support the housing.

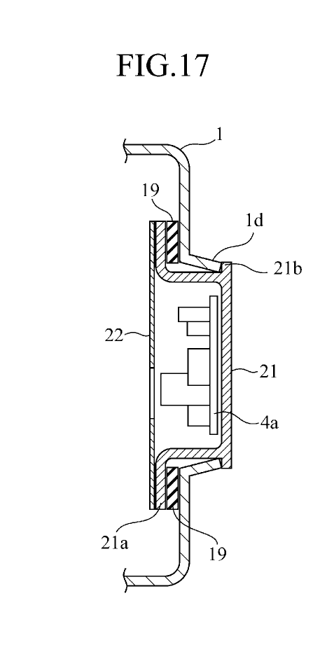

FIG. 17 shows a modification of Embodiment 7: the edge portion of an opening 18 of a headlamp case 1 is turned back in a tapered manner to form an engaging convex portion 1d, an engaging concave portion 21a is formed in the outer peripheral surface of the tip of a housing 21, and the housing 21 inserted into the headlamp case 1 from the front opening portion 1a is protruded from the opening 18 to the outside; in the process of the protrusion, when the tip of the housing 21 is passed through the outwardly push-expanded, engaging convex portion 1d, the engaging convex portion 1d is reduced in diameter and engaged with the engaging concave portion 21b, which functions so that no housing 21 returns to the inside of the headlamp case 1.

According to Embodiment 7, when the housing 21 is assembled thereto, it is possible to easily assemble and fix the housing 21 without using a fixing member of a screw and so on, and through no use of a special tool, thereby achieving a reduction in cost and an improvement in workability by a reduction in the fixing member of the screw and so on.

### Embodiment 8

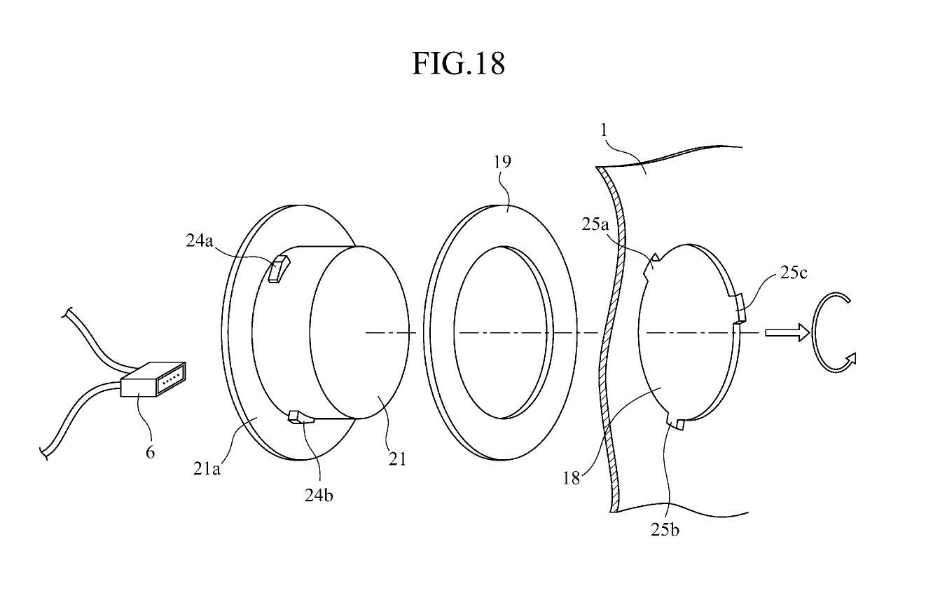

FIG. 18 shows Embodiment 8, and has a configuration in which a housing 21 is attached and fixed to a headlamp case 1 by a bayonet method, a plurality of engaging convex portions 24a, 24b, and 24c (24c is not shown) are provided on the outer peripheral surface of the housing 21, and notches 25a, 25b, and 25c passed through by the engaging convex portions 24a, 24b, and 24c are provided in the opening edge of the headlamp case 1.

With the above-mentioned configuration, the housing 21 is inserted into the headlamp case 1 with fit into a waterproof member 19; the engaging convex portions 24a, 24b, and 24c are passed through an opening 18 with aligned with the notches 25a, 25b, and 25c, and then rotated in a direction of an arrow, so that the engaging convex portions 24a, 24b, and 24c are brought into contact with the outer surface of the headlamp case 1. In this instance, when the engaging convex portions 24a, 24b, and 24c are formed with inclined surfaces such that the thicknesses of the convex portions 24a, 24b, and 24c are gradually increased in the direction of the rotation, it is possible to strongly press the waterproof member 19 to firmly assemble and fix the housing 21 within the headlamp case 1 upon completion of the rotation.

In addition, the engaging convex portions 24a, 24b, and 24c of the housing 21 are provided at sections to be passed through the opening 18 of the headlamp case 1, and can also be provided on the section of the heat dissipating fin of FIG. 11 or the housing of FIGS. 13 and 14.

According to Embodiment 8, as in Embodiment 7, when the lighting device 4 is assembled thereto, it is possible to easily assemble and fix the housing 4 without using a fixing member of a screw and so on, and through no use of a special tool, thereby achieving a reduction in cost and an improvement in workability by a reduction in the fixing member of the screw and so on.

### Embodiment 9

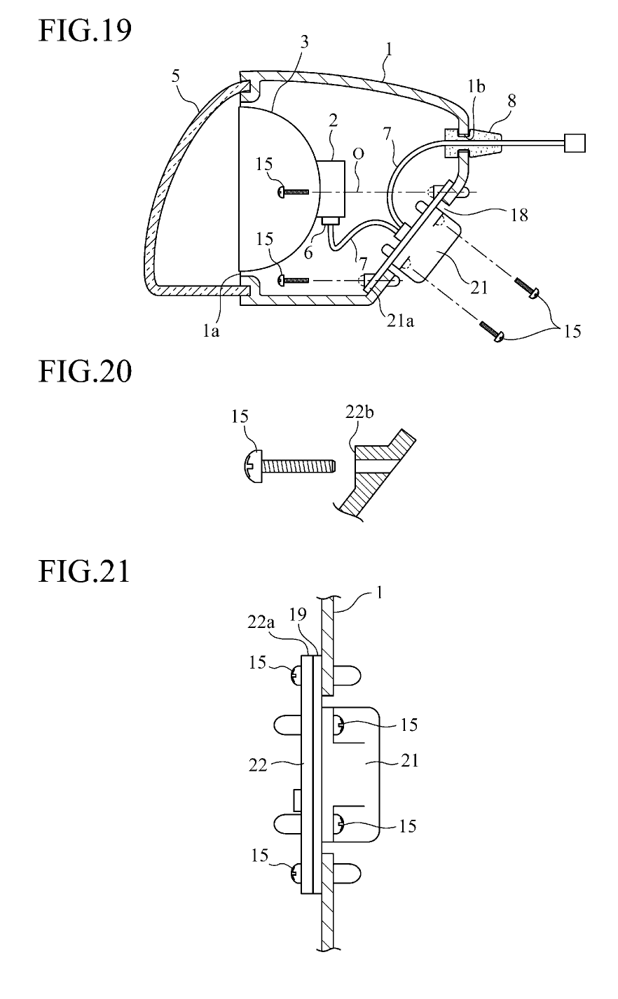

FIG. 19 shows Embodiment 9, and in a case where a vehicle-mounted member except the members constituting a headlamp is disposed at a position immediately behind the headlamp, it is difficult to secure an inner wall orthogonal (vertical) to an axial direction in which a front opening portion 1a of a headlamp case 1 is formed; therefore, an opening 18 passed through by a part of a housing 21 is formed in an inclined inner wall of the headlamp case 1, a planar fixation section 21a of the housing 21 that is brought into contact with the headlamp case 1 is positioned along the inclined inner wall of the headlamp case, and as shown in FIG. 20, the axial direction for fastening of the fixing screw 15 is set as the axial direction in which the front opening portion 1a of the headlamp case 1 is formed.

Note that as shown in FIG. 20, when a fixing screw bearing surface 22b provided on a closing member 22 is set as a surface orthogonal to an axis O in which the front opening portion 1a of the headlamp case 1 is formed, the fastening force by the screw 15 is stabilized, so that the assemblability of the housing 21 constituting the lighting device 4 is improved.

According to Embodiment 9, since it is possible to assemble the housing 21 to the inner wall except the inner wall orthogonal (vertical) to the axial direction in which the front opening portion 1a of the headlamp case 1 is formed, the degree of freedom in the selection of the position to which the housing 21 is attached is increased, while it is possible to effectively use the space of a vehicle by using a vacant space; further, since the rear region of the headlamp is not used, it is possible to reduce the length of the headlamp in a front-rear direction.

Furthermore, it is possible to align the rotation axis of a driver, which is used in the assembly of the housing 21 to the headlamp case 1, with the axis of the front opening portion 1a of the headlamp case 1, thereby improving the workability.

### Embodiment 10

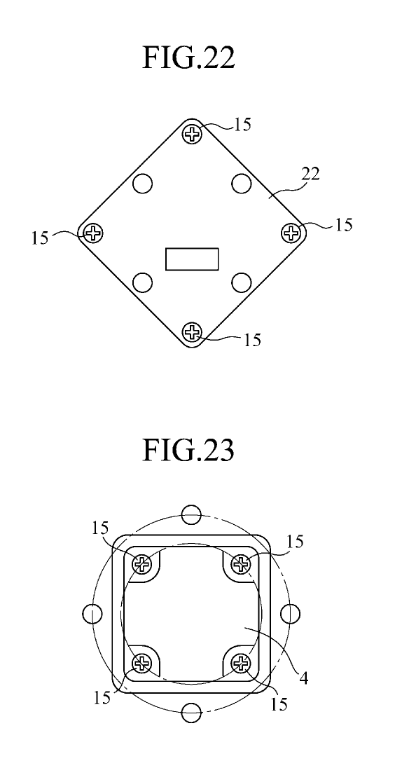

FIGS. 21 to 23 show Embodiment 10 and has a configuration in which a waterproof member 19 is provided between a housing 21 accommodating constituent components and a closing member 22 for closing the opening portion of the housing, arranged positions of screws 15 that fix a planar fixation section 22a provided on a closing member 22 to a headlamp case 1 and arranged positions of the screws 15 that fix the housing 21 to the closing member 22 are located on respective substantial circles, and an angle arranging the screws 15 for fixing the housing 21 and an angle arranging the screws 15 for fixing the closing member 22 are set to different angles which do not interfere with each other.

According to Embodiment 10, the position for fixing the housing 21 and the position for fixing the closing member 22 do not interfere with each other, and therefore it is possible to reduce a space occupied by the housing 21, reduce the size of the housing 21 including the planar fixation section 21a, and reduce the area of the inner wall of the headlamp case 1 to which the housing 21 is attached. In addition, it is possible to prevent the entry of water into the headlamp case 1 to secure the waterproof property and high heat-dissipation property of the headlamp case 1.

### Embodiment 11

As a light source to be lighted by the lighting device 4 of Embodiments 1 to 10, a semiconductor light source including an LED is employed. When the LED is used as the light source, the light source has long life and requires no replacement, and a lighting device having a high assemblability is effectively obtained.

### INDUSTRIAL APPLICABILITY

As described above, the light source lighting device for a headlamp according to the present invention is effectively applied to a vehicle headlight which uses the discharge lamp or the LED as the light source.

1. An LED light source lighting device for a headlamp comprising:
a headlamp case to which a front lens is attached; and
a planar fixation section that is inserted into the headlamp case, together with an optical component having a light source, from a front opening portion formed in the headlamp case, and that is fixed along an inner wall of the headlamp case.

2. The LED light source lighting device for a headlamp according to claim 1, wherein the planar fixation section fixed along the inner wall of the headlamp case is provided with a plate member that is interposed therebetween and that has a function of dissipating heat emitted by a constituent component.

3. The LED light source lighting device for a headlamp according to claim 2, wherein at least a part of the plate member is exposed from an opening provided in the headlamp case to the outside.

4. The LED light source lighting device for a headlamp according to claim 2, wherein a heat dissipating convex portion is provided on a part of the plate member, and the convex portion is protruded from an opening provided in the headlamp case to the outside.

5. The LED light source lighting device for a headlamp according to claim 1, wherein a constituent component is accommodated in a housing having a function of dissipating heat emitted by the constituent component, the planar fixation section pressed against and fixed to the inner wall of the headlamp case is provided on an opening peripheral edge portion of the housing, and at least a part of the housing is protruded from an opening provided in the headlamp case to the outside.

6. The LED light source lighting device for a headlamp according to claim 1, wherein a constituent component is accommodated in a housing having a function of dissipating heat emitted by the constituent component, a closing member for closing an opening of the housing is provided, the planar fixation section pressed against and fixed to the inner wall of the headlamp case is provided on the closing member, and at least a part of the housing is protruded from an opening provided in the headlamp case to the outside.

7. The LED light source lighting device for a headlamp according to claim 1, wherein it is configured that a part of a housing having a function of dissipating heat emitted by a constituent component accommodated therein is protruded to the outside of the headlamp case, the planar fixation section pressed against and fixed to the inner wall of the headlamp case is provided on the housing, and a convex portion that comes in contact with an outer wall of the headlamp case or a concave portion in which a convex portion provided on the outside of the headlamp case is fitted is provided at a section protruded to the outside of the headlamp case.

8. The LED light source lighting device for a headlamp according to claim 2, wherein a waterproof member is provided between the planar fixation section and the inner wall of the headlamp case.

9. The LED light source lighting device for a headlamp according to claim 6, wherein a waterproof member is provided between the planar fixation section provided on the closing member and the headlamp case, or between the housing accommodating the constituent component and the closing member for closing the opening of the housing.

10. The LED light source lighting device for a headlamp according to claim 6, wherein a direction of attachment of a fixing member for fixing the planar fixation section of the closing member for closing the opening of the housing to the headlamp case and a direction of attachment of a fixing member for fixing the closing member to the housing are set to be different from each other.

11. The LED light source lighting device for a headlamp according to claim 6, wherein an attachment position where the planar fixation section provided on the housing is fixed to the headlamp case and an attachment position where the housing is fixed to the closing member are set to positions on a substantially identical circle which do not interfere with each other.

12. (canceled)
